(19) United States
(12) Patent Application Publication
(10) Pub. No.: US 2025/0353655 A1
(43) Pub. Date: Nov. 20, 2025

(54) Heat-Sealable Lidding Film Capable of Use with Cups of Carbonated Beverages, or the Like

(71) Applicant: Printpack Illinois, Inc., Elgin, IL (US)

(72) Inventors: Louis R. Duckwall, JR., Marietta, GA (US); Jayme Elizabeth Walton, Decatur, GA (US)

(21) Appl. No.: 17/982,881

(22) Filed: Nov. 8, 2022

Related U.S. Application Data
(60) Provisional application No. 63/277,315, filed on Nov. 9, 2021.

(51) Int. Cl. B65D 77/20; A23L 2/54; B65D 85/72

(52) U.S. Cl. CPC B65D 77/2028; A23L 2/54; B65D 85/72; A23V 2002/00; B65D 2577/2091

(57) ABSTRACT

Cut portions of packaging material can be used as film lids that are respectively heat sealed to mouths of cups of carbonated beverage to close openings of the cups. The film lids can be configured in a manner that seeks to optimally maintain both package integrity and beverage freshness, and provide selective access to the carbonated beverage. The film lids can include diffusion-controlling microperforations. The film lids can include access-providing score lines.

### CROSS-REFERENCE TO PRIORITY APPLICATION

This application claims the benefit of U.S. Provisional Patent Application No. 63/277,315, filed Nov. 9, 2021, which is hereby incorporated by reference in its entirety.

### BACKGROUND

The present invention generally relates to lids for containers and, more particularly, to heat-sealable lidding films that may be used as lids for cups.

It is known to form hermetically sealed lids on cups using conventional heat-sealable lidding films. For example, it is known to bring a piece of heat-sealable polypropylene (PP), polyethylene terephthalate (PET), or polyethylene (PE) lidding film into contact with the rim of a PP, PET, or PE-coated paper cup, respectively, and apply heat and pressure so that the lidding film bonds (i.e., seals) to the rim of the cup. The lidding film may be pre-cut or may be cut during the heat sealing process.

When the cup contains a beverage, the sealed film lid can keep the beverage from spilling out of the cup and prevent contaminants from entering the cup. When the beverage is to be consumed, it is typical for the film lid to be manually peeled apart from and off of the cup.

It is believed that if a conventional heat-sealable lidding film is used to form a hermetically sealed lid on a cup containing a carbonated beverage (e.g., a fountain beverage containing dissolved carbon dioxide), carbon dioxide gas released from the beverage may build up in a headspace of the cup and exert outwardly oriented pressure on the sealed film lid. In some circumstances, the buildup of pressure in the cup may at least contribute to undesirable, unintentional rupturing of the seal between the lid and cup. Seal failure can contribute to spillage and/or contamination of the beverage. Additionally or alternatively, the buildup of pressure in the cup may at least contribute to undesirable outward spewing when the film lid is opened.

There is a desire for lidding film that provides a new balance of properties.

### SUMMARY

An aspect of this disclosure is the provision of a packaging material that is capable of being used as lidding film, for example heat-sealable lidding film. Cut portions of the packaging material can be used as film lids that are respectively heat sealed to mouths (e.g., rims) of containers to close the openings of the containers and, thus, form packages. The containers can be cups containing carbonated beverage. The film lids can be configured in a manner that seeks to optimally maintain both package integrity and beverage freshness, and provide at least one predetermined type of selective access to the carbonated beverage. More specifically, the film lids can be configured to both allow sufficient carbon dioxide diffusion to inhibit failures (e.g., inadvertent heat seal failure) associated with over pressurization, and limit the rate of carbon dioxide diffusion to maintain freshness for a reasonable amount of time. The packaging material and film lids can include access-providing lines of disruption (e.g., score lines) and/or diffusion-controlling microperforations, as discussed further below.

As an example, a package can include a cup having a rim extending around an opening to an interior space of the cup, carbonated beverage in the interior space of the cup, a flexible thermoplastic polymeric film, and an annular heat-formed seal. The seal can fixedly connect the rim and an annular portion of the film to one another so that a central portion of the film obstructs the upper opening of the cup. The seal can be at least partially formed by thermoplastic material of the film.

A score line (e.g., laser-formed score line) can be defined in the central portion of the film. The score line can be configured to be selectively breached to at least partially form a hole for providing access to the carbonated beverage by way of a conventional drinking straw.

At least one microperforation can be defined in the central portion of the film. Prior to any breaching of the score line, the film can be configured to restrict carbon dioxide from diffusing outwardly from the interior space through the film, the at least one microperforation can be configured to allow carbon dioxide to diffuse outwardly from the interior space through the film, and the film and the seal can be cooperatively configured to restrict the carbonated beverage from passing outwardly through the opening of the cup. More specifically, it is believed that the film and the seal can be cooperatively configured to restrict the carbonated beverage from flowing outwardly through the opening of the cup when the cup is on its side or inverted.

For each film lid, the above-mentioned score line can be the only score line in the film lid, or there could be one or more additional score lines in the film lid. There can be a plurality of the microoperations in the film lid, and the microperforation(s) can be intersected by and/or extend along a lengthwise axis of the score line.

The foregoing summary provides a few brief examples and is not exhaustive, and the present invention is not limited to the foregoing examples. Various other features, aspects, and advantages of the present invention will be evident from the following description and accompanying drawings.

### BRIEF DESCRIPTION OF THE DRAWINGS

The drawings are provided as examples. The present invention may be embodied in many different forms and should not be construed as limited to the examples depicted in the drawings.

FIG. 1 is a schematic, exploded top-pictorial view of package including a cup and a film lid in accordance with an embodiment of this disclosure.

FIG. 2 is a schematic side-elevation view of the package of FIG. 1 in its closed configuration and further including carbonated beverage in the cup, wherein the upper surface of the liquid is hidden from view and schematically depicted by a dashed line.

FIG. 3 is a schematic, isolated top-plan view of the film lid of FIG. 1; and FIG. 3 is also schematically illustrative of a top-plan view of the package of FIG. 2.

FIG. 4 is a top-plan, schematic, isometric view of the package of FIG. 2 in a partially open configuration, with a conventional drinking straw extending through a hole in the lidding film, in accordance with an embodiment of this disclosure.

FIG. 5 is a schematic pictorial view of a strip or web of packaging material (e.g., heat-sealable lidding film) extending from a roll, in accordance with an embodiment of this disclosure.

### DETAILED DESCRIPTION

Examples of embodiments are disclosed in the following. The present invention may, however, be embodied in many different forms and should not be construed as limited to the embodiments set forth herein. For example, features disclosed as part of one embodiment or example can be used in the context of another embodiment or example to yield a further embodiment or example. As another example of the breadth of this disclosure, it is within the scope of this disclosure for one or more of the terms “substantially,” “about,” “approximately,” and/or the like, to qualify each of the adjectives and adverbs of the Detailed Description section of disclosure, as discussed further below.

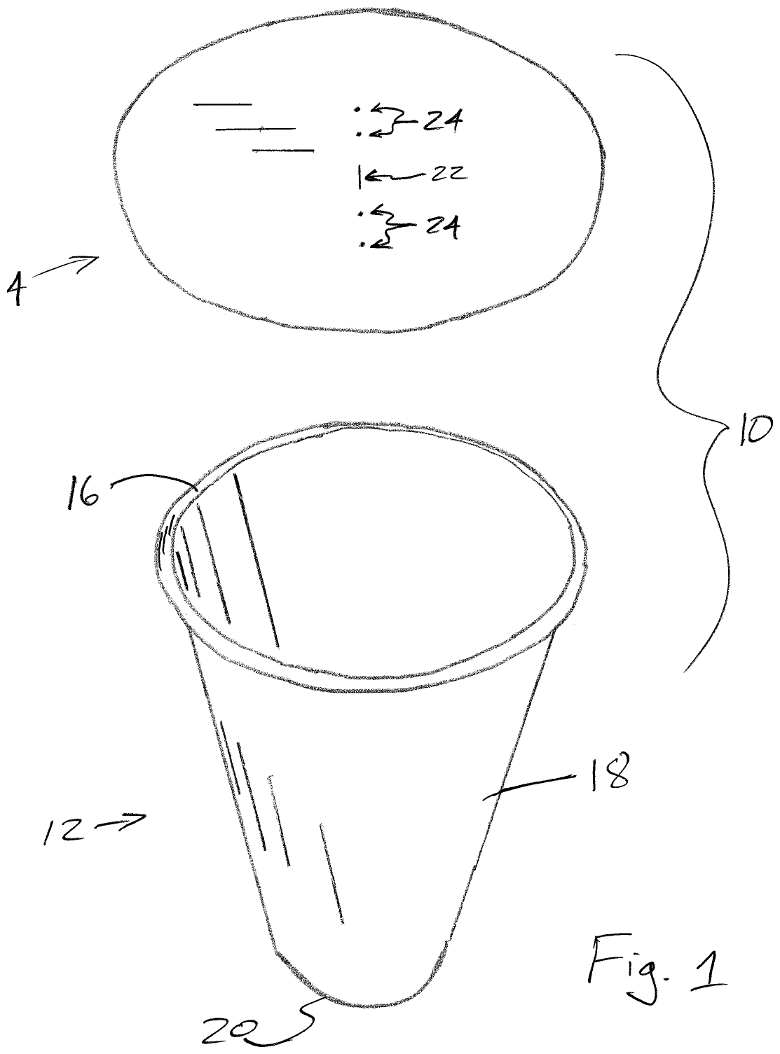

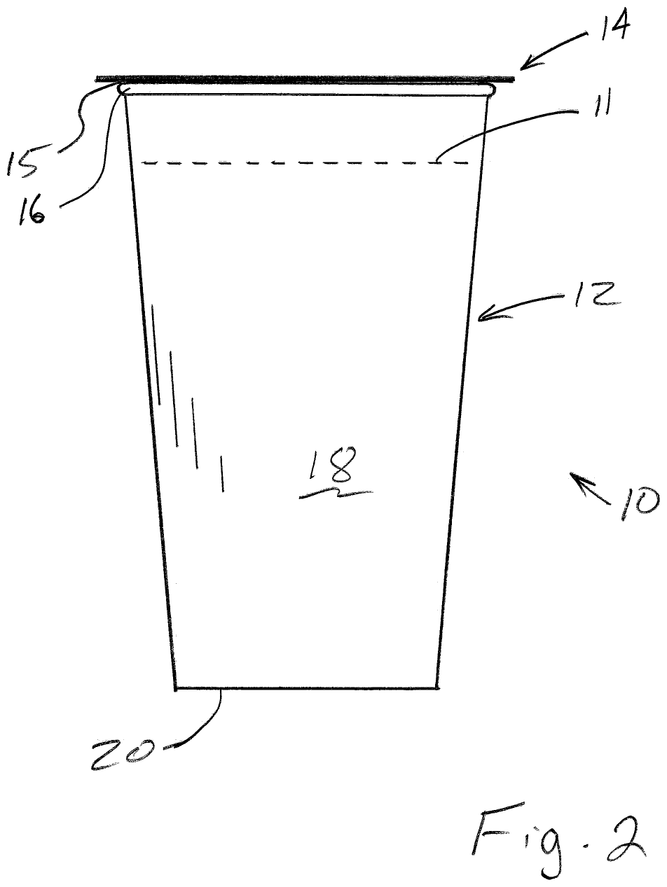

Referring to FIGS. 1 and 2, a package 10 of an embodiment of this disclosure includes carbonated beverage 11 (FIG. 2, e.g., carbonated water, carbonated soft drink, and/or carbonated alcoholic drink) in a cup 12 or other suitable container that is closed by a film lid 14. FIG. 1 is an exploded view of the cup 12 and film lid 14 of the package 10, without the carbonated beverage 11. In FIG. 2 the carbonated beverage 11 is hidden from view, and the upper surface of the carbonated beverage is schematically represented by a dashed line. The carbonated beverage 11 can be part of a mixture that further includes ice and/or other suitable substances that are conventionally included with carbonated beverage.

FIG. 2 depicts the package 10 in a fully closed configuration (e.g., completely unopened configuration). In the closed configuration of FIG. 2 the upper opening of the cup 12 is obstructed, or more specifically hermetically sealed closed, by the film lid 14. The film lid 14 can be formed from a piece of heat-sealable, flexible lidding film configured to allow for a predetermined amount of carbon dioxide diffusion, as discussed further below.

Referring to FIG. 2, for providing the fully closed configuration, the film lid 14 can be heat-sealed to a mouth (e.g., rim 16) of the cup 12, so that lid and cup are sealed together (e.g., connected to one another) at an annular heat seal 15 between the film lid 14 and an annular upper rim 16 of the cup 12. The heat seal 15 can be formed by one or more thermoplastic polymeric materials (e.g., at least one thermoplastic polymeric material of the lid, at least one thermoplastic polymeric material of the cup, and/or thermoplastic polymeric materials respectively of the lid and cup). The film lid 14 can be or include a film of thermoplastic polymeric material (e.g., polypropylene (PP), polyethylene terephthalate (PET), and/or polyethylene (PE)); and/or the cup 12 can comprise or be formed of thermoplastic polymeric material (e.g., PP, PET, or PE-coated paper). The heat seal 15 can be formed by raising the temperature of respective portion(s) of at least one of the thermoplastic polymeric materials to above its melting temperature or at least to a suitable activation temperature, and applying suitable pressure for a suitable period of time.

As best understood with reference to FIG. 2, the annular peripheral margin of the sealed film lid 14 can extend farther outwardly than the cup's rim 16. Relative to the rim 16, the outer peripheral edge of the film lid 14 can extend farther outwardly or less farther outwardly than depicted in FIG. 2.

FIG. 2 may be schematic because, for example, it is believed that the thickness of the film lid 14 may be exaggerated, and the flatness of the annular peripheral margin of the film lid positioned outwardly from the heat seal 15 and rim 16 may be exaggerated. Stated differently, the film lid's annular margin, which is positioned outwardly from the heat seal 15 and rim 16, may not be planar (e.g., one or more portions of the lid's our annular margin may define or be in an undulated or wavy configuration).

As an example of a method, the cup 12 can be at least partially filled with the carbonated beverage 11 dispensed from a fountain or tap (e.g., soda fountain) directly into the cup, and then the film lid 14 can quickly be conveniently and cost-efficiently hermetically heat-sealed to the rim 16 to close the cup's opening (e.g., form the heat seal 15 to provide the fully closed configuration of the package 10) and help maintain freshness of the beverage in the cup. While the heat-sealed film lid 14 remains fully connected to the cup 12 by the heat seal 15, the film lid can prevent contaminants (typically at least macroscopic particles larger than any molecules that may diffuse through the film lid) from entering the cup 12. The heat seal 15 can be strong enough to remain intact (e.g., provide a securely fixed connection (e.g., hermetic seal) between the rim 16 and a corresponding annular portion of the film lid 14) in a majority of reasonable conditions under which it is desired that the package 10 reman closed.

The heat-sealed film lid 14 can function to restrict (e.g., partially restrict or at least partially restrict) the escape of carbon dioxide from the package 10 to inhibit the beverage in the cup 12 from becoming “flat” too quickly (e.g., delays the process by which carbon is released from the package through the film lid and, thus, delays the process by which the carbon is released from the beverage 11 and, thus, delays the beverage becoming flat). The film lid 14 can be configured to restrict the escape of carbon dioxide from the package 10 by restricting molecular diffusion of carbon dioxide through the film lid. By restricting diffusion, the film lid 14 can function to maintain the freshness of the carbonated beverage 11 in the package 10 (e.g., lidded cup 12) for a predetermined, reasonable period of time, for example, while the package is being transported (e.g., for take-out from a restaurant), while the package sits behind a counter at a restaurant in anticipation of the lidded cup eventually being provided to a customer, and/or during other reasonable delays between the cup being filled with the beverage and the beverage being consumed.

The sealed film lid 14 (e.g., at least the central portion and/or another suitable portion of the film lid) can be configured to advantageously simultaneously restrict the rate at which the carbon dioxide gas is released from the package 10 and relieve any excess pressure resulting from a buildup of carbon dioxide gas that is released from the beverage in the cup 12. For example, the carbon dioxide gas released from the beverage 11 can accumulate in the cup's headspace (e.g., a portion of the cup's interior space positioned between the upper surface of the beverage 11 and the film lid 14) over time (e.g., 1-2 hours, or less when the cup 12 is physically agitated (e.g., shaken or dropped)).

Without the sealed film lid 14 being configured to relieve any excess pressure in the headspace, any such excess pressure may at least contribute to (i) undesirable rupturing of the heat-formed seal 15 between the lid and cup 12 and/or (ii) undesirable (excessive) outward spewing when the film lid is opened. For releasing any such excess pressure or inhibiting the build up of pressure, and retaining some of the carbon dioxide in the package 10 for a reasonable amount of time, the film lid 14 can be configured to diffuse gas (e.g., diffuse at least carbon dioxide), as discussed further below.

In the embodiment depicted in FIGS. 1 and 2, the cup 12 includes a frustoconical sidewall 18 (e.g., at least one sidewall) extending between the rim 16 and a closed base 20 of the cup. The sidewall 18 extends around an interior space of the cup 12. The rim 16 or other suitable upper annular edge of the sidewall 18, or the like, extends around and defines the upper opening to the cup interior space 12. The rim 16 can be an outwardly rolled portion of the sidewall 18, or the rim or upper cup opening can be formed in any other suitable manner (e.g., an unrolled upper edge of the sidewall 18 can be referred to as the rim).

An annular portion of a lower surface of the film lid 14 can be heat sealed to the top of the rim 16 so that a central portion the film lid 14 obstructs the opening to the cup's interior space. In an embodiment of this disclosure, the cup 12 comprises polymeric material that at least partially defines an exterior surface of the rim 16, and the annular portion of the thermoplastic film lid 14 is heat sealed to the top of the exterior surface of the rim.

Reiterating from above with reference to FIG. 2, the annular peripheral margin of the sealed film lid 14 can extend farther outwardly than the heat seal 15 and cup's rim 16. As an example of a method for opening the package 10 and accessing the carbonated beverage 11 in the cup 12, the film lid 14 can be at least partially removed from the cup 12 by manually grasping a portion of the peripheral margin of the film lid and pulling the film lid at least partially away from the cup (e.g., to break the heat-formed seal 15 between the film lid and cup). Stated somewhat similarly, the heat seal 15 can be configured (e.g., have or define a peel strength) so that the film lid 14 can be manually peeled apart from at least a portion of the rim 16 at least by a typical adult. Additional or alternative feature(s) for obtaining access to the carbonated beverage 11 in the cup are discussed further below. In this regard, it is believed that in some configurations manual breaching of the heat seal 15 can be discouraged or restricted by the peripheral margin of the sealed film lid 14 not extending farther outwardly than, or extend only slightly farther outwardly than, the cup's rim 16 and/or the heat seal 15 being strong enough to discourage or restrict peeling of the film lid.

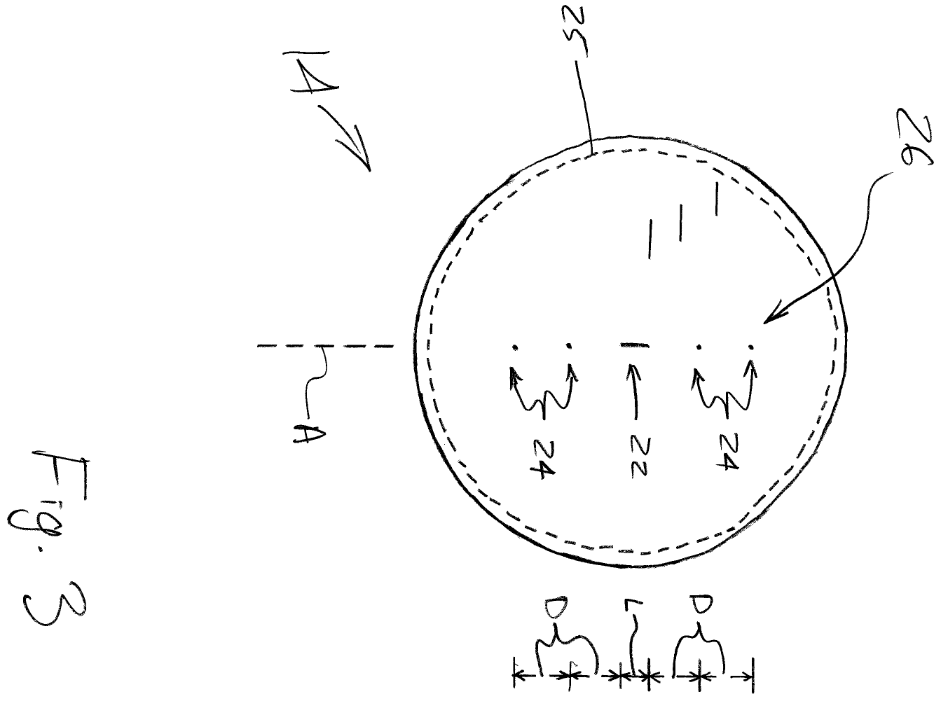

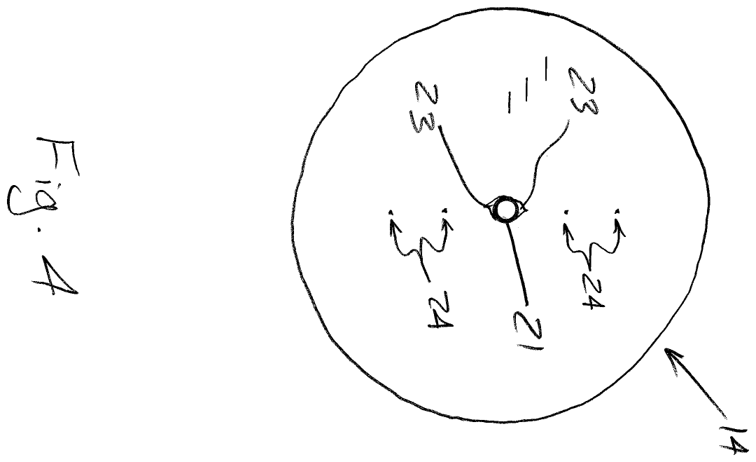

In the embodiment depicted in the drawings, the central portion of the film lid 14 includes at least one feature configured for providing of access to the carbonated beverage 11 in the cup 12. This access feature of the central portion of the film lid 14 can comprise at least one feature configured for having a conventional drinking straw 21 (FIG. 4) extend therethrough, so that the carbonated beverage 11 can be sucked from the cup 12 through the straw, as discussed further below. Referring to FIGS. 1 and 3, the access feature in the central portion of the film lid 14 can comprise, consist essentially of, or consist of a disruption, line of disruption, score line, or more specifically a laser-formed score line 22 (e.g., an elongate laser-cut hole) that extends only partially through the thickness of the film lid. It is believed that the laser-formed score line may be, or may be referred to as, a kiss cut line that extends only partially through the thickness of the film lid. It is believed that the score line 22 or kiss cut may alternatively be formed mechanically by a sharp edge or blade that penetrates only through a partial thickness of the film lid 14, as discussed further below. The thickness of the film lid 14 is defined between opposite inner and outer surfaces of the film lid, wherein the inner surface of the film lid is in opposing face-to-face relation with the carbonated beverage 11, and the outer surface of the film lid is in opposing face-to-face contact with ambient environment.

The portion of the film lid 14 including the laser-formed score line 22 can be configured to be breached by, for example, being engaged (e.g., pierced) by a lower end of the conventional tubular drinking straw 21 (FIG. 4) that is manually forced downwardly into contact with the score line 22 to breach the score line and, thus, form a through hole 23 (FIG. 4) in the film lid. In this regard, FIG. 4 depicts the package 10 in an example of a partially open configuration. More specifically, FIG. 4 depicts a top-plan isometric view of the package of FIG. 2 with the conventional drinking straw 21 extending through a through hole 23 in the film lid 14, wherein the lengthwise axes of the cup 12 and straw are coaxial, so that only the upper end of the straw is seen and the upper end of the straw is substantially depicted as a circle. That said, non-circular straws are within the scope of this disclosure. More generally, a variety of different relative positions between the axis of the cup 12, axis of the straw 21, and/or hole 23 are within the scope of this disclosure. For example, the lengthwise axis of the straw 21 may more typically be inclined relative to the lengthwise axis of the cup 12 while the straw extends through the hole in the film lid 14.

More specifically regarding an example of a method, at least the portion of the film lid 14 proximate or immediately adjacent (e.g., beneath or above) the laser-formed score line 22 can be torn by being firmly engaged by the end of the straw 21, or the like, so that the score line 22 and torn portion together form a slit or through hole 23 that extends through the entire thickness of the film lid. The lower end of the straw 21 can be passed through this partially torn through hole 23 so that the lower end of the straw is submerged in the beverage 11 in the cup 12, an intermediate portion of the straw extends through the central portion of the film lid 14, and the upper end of the straw is exposed above the film lid so that a user can engage their lips upon and drink from the upper end of the straw. Alternatively, the score line 22 and through hole 23 partially formed therefrom can be positioned off-center in the film lid 14, and the score line can be omitted or replaced with one or more other suitable access-providing features.

At least partially reiterating from above, the sealed film lid 14 can be configured (e.g., can have a predetermined effective diffusivity) in order to both retain a desirable amount of carbon dioxide in the package 10 for a reasonable amount of time, and inhibit build up of any excess pressure in the cup's headspace (e.g., release pressure from within the headspace) while the package remains in its fully closed configuration. These characteristics can be provided, for example, by (i) the film lid 14 being formed of microporous material configured so that the film lid is permeable to carbon dioxide gas at an appropriate diffusion rate, and/or (ii) the film lid having one or more of, for example an appropriate number and size of, disruptions, holes, or microperforations 24 (e.g., laser-cut holes) so that carbon dioxide gas can diffuse through the microperforations (e.g., through holes) at an appropriate diffusion rate. In either case, the film lid 14 can be configured to prevent the liquid beverage from flowing outwardly from the interior space through the sealed closed film lid (e.g., the lid can be impermeable to liquid) prior to any score line 22, or the like, being torn open. Each of the one or more microperforations 24 (e.g., laser-formed microperforation(s)) typically extend through the entire thickness of the film lid 14, although variations are within the scope of this disclosure. Each microperforation 24 can be more generally referred to as an opening or a hole, for example an opening extending completely through the film lid, a hole extending completely through the film lid (e.g., a through hole), or the like. The material of the film lid 14 can be configured so that, without the microperforation(s) 24, any flow rate or diffusion through the fully intact film lid would be insignificant, or substantially insignificant, for the purposes of this disclosure.

At least partially reiterating from above, the film lid 14 can be configured to both (i) be impermeable to the liquid carbonated beverage 11 prior to any score line 22, or the like, being torn open, and (ii) allow carbon dioxide gas dissoluted from the carbonated beverage to diffuse through film lid (e.g., the microperforation(s) 24) prior to any score line, or the like, being torn open. As an example, it is believed that the released carbon dioxide can diffuse through the film lid 14 (e.g., by way of the microperforation(s) 24) at a rate that is both (i) low enough so that carbon dioxide gas dissoluted from the carbonated beverage 11 causes positive gauge pressure in the interior space and/or the beverage remains carbonated for more than an hour, at least two hours, or another suitable timeframe, and (ii) large enough to restrict the positive gauge pressure from becoming too high (e.g., high enough to unintentionally break the annular heat seal 15 between the cup's rim 16 and film lid and/or cause undesirable (e.g., excessive) spewing when the film lid is intentionally opened). The heat seal 15 and other parts of the package 10 can be strong enough to maintain the package in its fully closed configuration while the pressure in the cup's headspace exceeds ambient pressure.

As example regarding diffusion through the film lid 14 or more specifically diffusion through one or more of, a majority of, or each of, the microperforations 24, an air flow rate of from about 30 cc/minute per microperforation to about 50 cc/minute per microperforation has been calculated, an air flow rate of from about 30 cc/minute per microperforation to about 40 cc/minute per microperforation has been measured, and/or any values or ranges (e.g., subranges) therebetween. As another example, it is believed that for a film lid 14 with four microperforations 24 having an average crosswise dimension (e.g., diameter) of about 110 microns, and an average carbon dioxide flowrate of from about 50 cc/minute per microperforation to about 70 cc/minute per microperforation, the film lid 14 as a whole may have a carbon dioxide flow rate of from about 200 cc/minute to about 280 cc/minute, and/or any values or ranges (e.g., subranges) therebetween. For the purpose of each of the examples in this paragraph, it is believed that relevant parameters can be described as the film lid 14 being in its fully closed configuration; the material of the film lid being configured so that, without the microperforation(s) 24, any flow rate or diffusion through the film lid would be relatively insignificant; and the flowrate being driven by a differential pressure of about 15 psi across the film lid (e.g., pressure in the cup's head space exceeded ambient atmospheric pressure by about 15 psi).

The microperforation(s) 24 and the at least one score line 22 can be in a variety of configurations. An example of a specific configuration of the microperforation(s) 24 and score line(s) 22 is described in the following with reference to FIG. 3. In FIG. 3, the film lid 14 includes only the single score line 22 that is elongate, linear or straight in the direction perpendicular to the thickness of the film lid, and there are four of the microperforations 24, although different numbers of the score line and microperforations are within the scope of this disclosure.

As best understood with reference to FIG. 3, one or more of the microperforations 24 can be positioned along, can collectively extend along, or can be intersected by the lengthwise axis of the score line 22. In FIG. 3, a portion of the score line's lengthwise axis is schematically represented by a dashed line designated by reference letter A. In the embodiment depicted in the drawings, the score line 22 is centered between pairs of perforations 24, and the score line is linear and its lengthwise axis A intersects each of the perforations. That said, the plurality of perforations 24 can extend along, and be space apart from, the lengthwise axis A of the score line 22, or they may be in any other suitable configurations.

In accordance with an example, FIG. 3 depicts a top view of the package 10 in its fully closed configuration. Various features can be described with respect to (e.g., can be schematically represented by) the schematic dashed line or circle 25 in FIG. 3. For example and depending upon whether the film lid 14 is transparent, the heat seal 15 and cup rim 16 may be hidden from view in a top view of the package 10, and the schematic dashed circle 25 of FIG. 3 can be described as being representative of both the heat seal and rim, such that in this example the heat seal and rim are superposed with one another. As another example, the schematic dashed circle 25 of FIG. 3 can be described as representing an annular portion of the film lid 14 that is superposed with both the heat seal 15 and the and cup rim 16. In the embodiment depicted in the drawings, the annular portion of the film lid 14 represented by the schematic dashed circle 25 in FIG. 3 extends around and is contiguous with (and, thus, defines) a central portion of the film lid. The film lid's annular portion (which is represented the schematic dashed circle 25 of FIG. 3) and the film lid's central portion (which is encircled or bounded by the schematic dashed circle of FIG. 3) can be contiguous and coplanar with one another in the fully closed configuration of the package 10.

Referring to FIG. 3, the score line 22 can have a length L of about 0.25 inches, at least about 0.25 inches, less than about 0.5 inches, in a range of from about 0.15 inches to about 0.5 inches, in a range of from about 0.2 inches to about 0.4 inches, in a range of from about 0.2 inches to about 0.3 inches, and/or any values or ranges (e.g., subranges) therebetween. The distance D between adjacent microperforation and score line features can be about 0.5 inches, or at least about 0.5 inches.

It is believed that one or more of, a majority of, or each of, the microperforations 24 can have a crosswise dimension (e.g., diameter) of about 0.1 mm, of about 0.1 mm or less, in a range of from about 0.09 mm to about 0.11 mm, in a range of from about 0.08 mm to about 0.12 mm, in a range of from about 0.07 mm to about 0.13 mm, and/or any values or ranges (e.g., subranges) therebetween. One or more of, a majority of, or each of, the microperforations 24 can have a crosswise dimension (e.g., diameter) in a range of from about 105 microns (0.105 mm) to about 110 microns (0.11 mm), in a range of from about 75 microns to about 145 microns, and/or any values or ranges (e.g., subranges) therebetween. It is believed that one or more of, a majority of, or each of, the microperforations 24 can have an area, as measured perpendicular to the thickness of the film, of about 0.008 mm², of less than about 0.05 mm², of less than about 0.013 mm², in a range from about 0.005 mm² to about 0.012 mm², in a range from about 0.004 mm² to about 0.013 mm², and/or any values or ranges (e.g., subranges) therebetween.

The length L, distances D, and diameters each extend crosswise to the thickness of the film lid 14. The thickness of the film lid 14 can be about 2.30 mil, in a range of from about 1.6 mil to about 3.0 mil, and/or any values or ranges (e.g., subranges) therebetween. The thickness of the film lid 14 can be about 81 microns (0.081 mm), in a range of from about 105 microns to about 57 microns, and/or any values or ranges (e.g., subranges) therebetween.

The score line 22 can have a depth that is cut into the film lid 14 by laser or mechanical device so that the score line does not extend all the way through the film lid, and the depth of the score line is sufficient to facilitate the breaching of the score line with an end of the straw 21 or other suitable device. The depth of the score line 22 can be in a range of from about one quarter of the thickness of the film lid 14 to about three quarters of the thickness of the film lid. The thickness of the film lid 14 can be about 2.30 mil, and the score line 22 can extend in a range of from about 0.5 mil to about 1.9 mil into the thickness of the film lid. The thickness of the film lid 14 can be about 81 microns, and the score line 22 can extend in a range of from about 12 microns to about 60 microns into the thickness of the film lid.

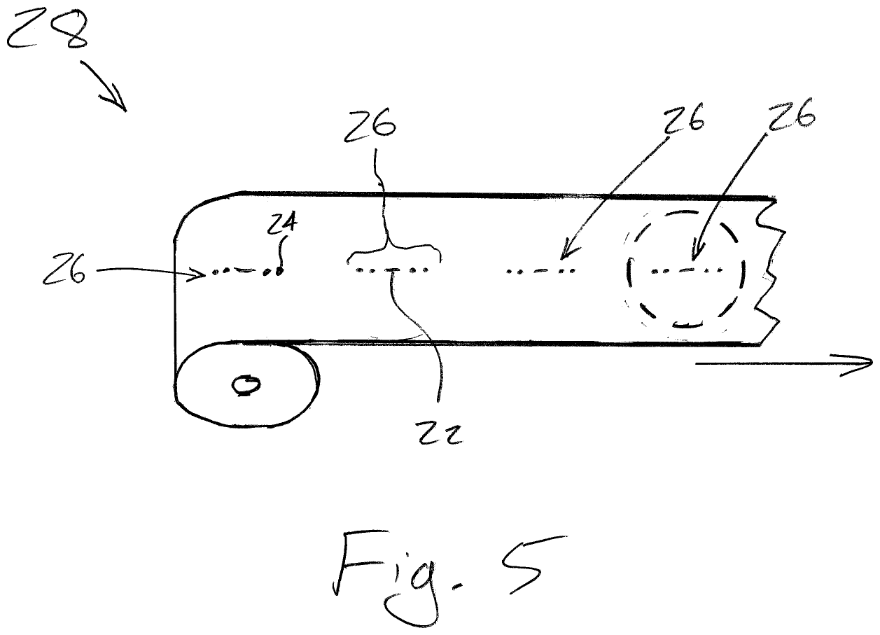

Film lids 14 can be respectively cut from a strip or web of packaging material 28 (FIG. 5) and be heat-sealed to cups 12 using a conventional cup heat-sealing machine (not depicted) typically shortly after the cups are at least partially filled with the carbonated beverage 11 and/or other suitable contents (e.g., non-carbonated beverages). In this regard, the score line 22 (e.g., laser-formed score line) and microperforations 24 (e.g., laser-formed microperforations) depicted in FIG. 3 can be collectively referred to as a unit of disruptions 22, 24 (e.g., unit 26). Referring to FIG. 5, the packaging material 28 (e.g., lidding film) comprises, consists essentially of, or consists of a strip of thermoplastic film that includes a pattern in which the unit 26 (e.g., unit or repeat of disruptions 22, 24) is repeated serially along the length of the film.

In FIG. 5, a dashed annular line extending around a representative unit 26 of disruptions 22, 24 schematically represents an example of where the cutting (e.g., slitting) of the packaging material 28 (e.g., lidding film) can occur in the conventional cup heat-sealing machine. In FIG. 5, the dashed annular line can be schematically representative of an annular cut or slit extending completely through the web of packaging material as part of separating the respective film lid 14 from the remnant of the packaging material, or the like.

Alternatively, the seal between the cup 12 and the film lid 14 can be at least partially formed by a cold-seal adhesive, and/or the seal and/or the film lid can be in other shapes (e.g., not circular). The film lids 14 and packaging material 28 can each be a single layer of film with or without printed indicia or graphics thereon, or they can be multilayer films or other suitable constructs with or without printed indicia or graphics thereon.

The relatively narrow web of packaging material 28 (e.g., lidding film) can be cut from a relatively wide web of packaging material (not depicted) that includes units 26 of the disruptions 22, 24 repeated in series along both the length and the width of the of the relatively wide web. The disruptions 22, 24 can be formed in the relatively web by a series of lasers (not depicted) spaced apart from one another in the direction crosswise to the direction in which the relative wide web is drawn past the laser. Each of the lasers (e.g., laser-emitting heads) can be a pulsed fiber laser, or any other suitable laser, operated in a predetermined manner to form the units 26 of the disruptions 22, 24 (e.g., laser-formed score lines 22 and/or laser-formed microperforations 24) while the precursor to the relative wide packaging material is drawn through a cutting station including the lasers.

Reiterating from above, it is within the scope of this disclosure for one or more of the terms “substantially,” “about,” “approximately,” and/or the like, to qualify each of the adjectives and adverbs of the foregoing disclosure, for the purpose of providing a broad disclosure. As an example, it is believed that those of ordinary skill in the art will readily understand that, in different implementations of the features of this disclosure, reasonably different engineering tolerances, precision, and/or accuracy may be applicable and suitable for obtaining the desired result. Accordingly, it is believed that those of ordinary skill will readily understand usage herein of the terms such as “substantially,” “about,” “approximately,” and the like.

In the specification and drawings, examples of embodiments have been disclosed. The present invention is not limited to such exemplary embodiments. The use of the term “and/or” includes any and all combinations of one or more of the associated listed items. Unless otherwise noted, specific terms have been used in a generic and descriptive sense and not for purposes of limitation.

1. A package comprising:
a cup comprising a rim extending around an opening to an interior space of the cup;
carbonated beverage in the interior space of the cup;
a flexible thermoplastic polymeric film, wherein the film comprises an annular portion extending around and contiguous with a central portion of the film;
an annular heat-formed seal at least partially formed by thermoplastic material of the film and fixedly connecting the rim and the annular portion to one another so that the central portion obstructs the opening to the interior space of the cup;
the film defining a score line, wherein the score line is defined in the central portion of the film, the score line is configured to be selectively breached to at least partially form a hole extending through the central portion for providing access to the carbonated beverage; and
the film defining at least one microperforation, wherein the microperforation is defined in the central portion of the film,
wherein, prior to any breaching of the score line:
the film is configured to restrict carbon dioxide from diffusing outwardly from the interior space through the film,
at least the at least one microperforation is configured to allow carbon dioxide to diffuse outwardly from the interior space through the film, and
the film and the seal are cooperatively configured to restrict the carbonated beverage from passing outwardly through the opening of the cup.

2. The package according to claim 1, wherein the score line is configured to be selectively breached by an end of a tubular drinking straw.

3. The package according to claim 1, wherein:
the score line is a laser-formed score line, and
the at least one microperforation is a laser-formed microperforation.

4. The package according to claim 1, wherein:
the annular portion of the film is superposed with the seal, and
the annular portion of the film and the central portion of the film are coplanar with one another.

5. The package according to claim 1, wherein:
the at least one microperforation extends through a thickness of the film,
the thickness is defined between opposite inner and outer surfaces of the film,
the inner surface of the film is in opposing face-to-face relation with the carbonated beverage, and
the outer surface of the film is in opposing face-to-face relation with ambient environment.

6. The package according to claim 5, wherein, measured perpendicular to the thickness of the film, the at least one microperforation has an area of less than 0.02 mm².

7. The package according to claim 5, wherein, measured perpendicular to the thickness of the film, the at least one microperforation has an area of less than 0.05 mm².

8. The package according to claim 5, wherein the score line is linear and has a lengthwise axis that intersects the at least one microperforation.

9. The package according to claim 5, wherein:
the at least one microperforation comprises a plurality of microperforations, and
the plurality of microperforations extends along a lengthwise axis of the score line.

10. The package according to claim 9, wherein the lengthwise axis of the score line intersects each microperforation of the plurality of microperforations.

11. A package comprising:
a cup comprising a rim extending around an opening to an interior space of the cup;
carbonated beverage in the interior space of the cup;
a flexible thermoplastic polymeric film, wherein the film comprises an annular portion extending around and contiguous (and substantially coplanar) with a central portion of the film;
an annular heat-formed seal at least partially formed by thermoplastic material of the film and fixedly connecting the rim and the annular portion to one another so that the central portion obstructs the opening to the interior space of the cup; and
the film defining only one score line, wherein the score line is defined in the central portion of the film, the score line has opposite ends and extends straight between the opposite ends, the score line is configured to be selectively breached to at least partially form a hole extending through the central portion for providing access to the carbonated beverage, the score line has a length extending from one of the opposite ends to another of the opposite ends, and the length is from about 0.15 inches to about 0.5 inches; and
wherein, prior to any breaching of the score line:
the film is configured to both restrict carbon dioxide from diffusing outwardly from the interior space through the film, and allow carbon dioxide to diffuse outwardly from the interior space through the film, and
the film and the seal are cooperatively configured to restrict carbonated beverage from flowing outwardly through the opening of the cup.

12. The package according to claim 11, wherein:
the annular portion of the film is superposed with the seal, and
the annular portion of the film and the central portion of the film are coplanar with one another.

13. The package according to claim 11, wherein:
the film defines a plurality of microperforations defined in the central portion of the film, and
the plurality of microperforation are configured to allow carbon dioxide to diffuse outwardly from the interior space through the film.

14. The package according to claim 1, wherein:
each of first and second microperforations of the plurality of microperforations extends through a thickness of the film,
the thickness is defined between opposite inner and outer surfaces of the film,
the inner surface of the film is in opposing face-to-face relation with the carbonated beverage, and
the outer surface of the film is in opposing face-to-face relation with ambient environment.

15. The package according to claim 14, wherein, measured perpendicular to the thickness of the film, the first microperforation has an area of less than 0.05 mm².

16. The package according to claim 14, wherein the plurality of microperforations extends along a lengthwise axis of the score line.

17. The package according to claim 14, wherein a lengthwise axis of the score line intersects both the first microperforation and the second microperforation.

18. The package according to claim 14, wherein a lengthwise axis of the score line intersects each microperforation of the plurality of microperforations.
